(19) United States
(12) Patent Application Publication
(10) Pub. No.: US 2006/0109834 A1
(43) Pub. Date: May 25, 2006

(54) Arrangement for input multiplexer

(75) Inventors: Tobias Kaesser, Stuttgart (DE); Michael Viertel, Duesseldorf (DE); Theo Wiesmann, Backnang (DE); Franz-Josef Goertz, Burgstetten (DE)

Correspondence Address: JORDAN AND HAMBURG LLP, 122 EAST 42ND STREET, SUITE 4000, NEW YORK, NY, 10168, US

(73) Assignee: TESAT-SPACECOM GMBH & CO. KG, Backnang (DE)

(21) Appl. No.: 10/538,588

(22) PCT Filed: Feb. 3, 2004
(86) PCT No.: PCT/DE04/00172

§ 371 Date: Nov. 17, 2005

(30) Foreign Application Priority Data
Feb. 3, 2003 (DE) 103 04 363.2

(51) Int. Cl. H04B 7/212

(52) U.S. Cl. 370/347; 370/342

(57) ABSTRACT

An input multiplexer, for which the high circuit order bandpass filters are connected by means of a low loss busbar of conducting pieces of optimized length into an IMUX.

The invention starts out from an input multiplexer (IMUX) of the type described in the main claim. This input multiplexer splits a broad frequency band into a series of narrow frequency bands. This is accomplished by filtering each frequency channel with a bandpass filter. In each case, the filters have an input and an output and must be connected suitably with one another.

The bandpass filters must fulfill strict configurations with respect to the frequency response of the amplitude as well as the phase response. Within the pass band of the bandpass filter, the variation in the phase or running time is to be minimized and, at the same time, the filters must have a high external band damping. This external band damping is achieved in that the zeroing of the transmission function is placed on the imaginary frequency axis close to the pass band. Additional measures are required in order to observe the requirement of little variation in the group running time in the pass band. For this purpose, essentially three different developments are state of the art.

In a first development, the filter itself is minimally phasic, that is, aside from the already mentioned zero positions, it has no other zero positions in the transmission function. In addition, the filter has an external running time equalizer. Frequently, the bandpass filter has the circuit order 8 and the equalizer has the circuit order 2.

In a further construction, the filter is self-equalizing, that is, aside from the zero positions of the transmission function mentioned, the bandpass filter has further ones with a finite real part. In this connection, the filter frequently has the circuit order 10 or 12, which is known, for example, from U.S. Pat. No. 5,608,363 especially for realization in a dielectric technology.

In the case of the third development, the bandpass filter itself is also self-antidistorting, as described above. In addition, however, and external running time antidistortion device is added. The filter frequently has the circuit order 10 or 12 here and the equalizer the circuit order 1 or 2. Such a development is described, for example, in U.S. Pat. No. 5,739,733, for which the electrical properties of the self-equalizing filter are improved by additional external running time equalizers, in that the filter equalizes the inclined position in the group running time.

The arrangement, with which the bandpass filters are coupled to one another, frequently consists therein that, initially, the signal input is split by means of a hybrid coupler or a power splitter into two equal parts, that is, each part is acted upon with half the signal level. Each of the two signal paths is processed further in that the signal is passed over a circulator chain to the bandpass filter. If the number of bandpass filters is n and if the bandpass filters are numbered 1, 2, 3, . . . n in the sequence, in which their center frequency increases, each of the two circulator chains connects the next neighbor but one, that is, the one circulator chain connects the bandpass filters 1, 3, 5, . . . n-1 and the other circulator chain the bandpass filters 2, 4, 6, . . . . n (if n is an even number; if n is an odd number, the two circulator chains contain the bandpass filters 1, 3, . . . n and 2, 4, . . . n-1 respectively). Such an arrangement is called non-contiguous, since each circulator chain only couples bandpass filters, the band limits of which do not lie directly next to one another in the frequency space.

It is a disadvantage of these arrangements that circulators changed their electrical properties as a function of the temperature and, in the overall arrangement, the circulator frequently is the limiting element for the temperature range, in which the overall arrangement still has the required properties. On passing through a circulator, the high frequency signal experiences appreciable high-frequency losses. Moreover, the individual signal outputs of an IMUX with circulated chain are dampened differently, since the signal, before passing through the bandpass filter, has experienced a different number of circulator passages. This effect is undesirable. Moreover, circulators contain magnetic and ferritic materials, which have an appreciable density. For this reason, circulators make an appreciable contribution to the total weight of the IMUX. Moreover, these magnetic and ferritic materials are used only in the circulators and require construction and connecting techniques, which are also used only in the circulator. Consequently, the assembly and testing require an appreciable expense. Moreover, the reliability of the arrangement as a whole is adversely affected by the circulators, which contribute appreciably to the price of the IMUX.

Arrangements, for which the signal input is divided not only into two but into several branches, which then terminate once again in circulator chains, are also used. Finally, it is also possible to divide the signal inputs in the bandpass filter exclusively by hybrid couplers or power splitters. These cause a disadvantageous signal damping of 3 dB and, in addition, have disadvantageous weights and volumes.

The arrangements for coupling bandpass filters, described so far, are used in the IMUX equipment. However, in order to understand the invention, a further device, the OMUX, must also be taken into consideration. This is similar to the IMUX, in that it does not bring together a broad frequency band into a series of narrower frequency channels, but, conversely, combines a series of narrower frequency channels into a broad frequency band. However, it is clearly different from IMUX, since it must process signals of a much higher power (in the OMUX, approximately 100 W per frequency channel, in the IMUX, approximately 1 mW per channel) and it is therefore a primary design objective to minimize losses. In comparison to the IMUX, it is simpler in the case of the OMUX that the individual bandpass filters only have to satisfy requirements, which are less strict and can generally be all observed with filters of a low circuit order (4 or 5). In particular, it is usually not necessary to take measures to ensure a flat course of the group running time within the pass band. In order to achieve low losses, the individual bandpass filters of the OMUX are combined with a busbar, as described in U.S. Pat. No. 4,614,920. This consists exclusively of conducting pieces of suitable length and therefore has only low losses. The busbar combines bandpass filters, which are immediately adjacent to one another in the frequency space. For this reason, the arrangement is considered to be contiguous.

On the other hand, the inventive input multiplexer with the characterizing, distinguishing features of the main claim, has the advantage that high circuit order bandpass filters, which, at the same time, satisfy strict requirements with respect to flank steepness and little variation in the group running time within the pass band, are connected into an IMUX by means of a low-loss bus bar consisting exclusively of conducting pieces of optimized length. Moreover, the bandpass filters have zero positions in the transmission function on the imaginary frequency axis close to the pass band in order to improve the flank steepness, and, in addition to the running time equalization, have either an external running time equalizer or further zero positions in the transmission function with a finite real part or a combination thereof.

According to an advantageous development of the invention, the busbar connects bandpass filters, which are not directly adjacent to one another in the frequency space (non-contiguous).

According to a further advantageous development of the invention, the busbar connects bandpass filters, which are directly adjacent to one another in the frequency space (contiguous).

According to a further advantageous development, the invention is realized in both developments in different technologies. In particular, these are the waveguide technique, the coaxial technique, the dielectric technique and the planar technique, the latter, in particular, in conjunction with superconducting materials. The individual bandpass filters and bus bars can be realized in different technologies.

According to a further, advantageous development of the invention, the geometry is realized combline or herringbone in both configurations, that is, the bandpass filters are all mounted on one side of the busbar or half on one side and half on the opposite side, so that the available space is used optimally, depending on the particular application.

According to a further, advantageous development of the invention, the bandpass filters are operated in single mode, dual mode, triple mode or quadruple mode in both configurations. Arbitrary combinations of these are also possible.

According to a further, advantageous development of the invention, the filters, with respect to their center frequency, are connected in any sequence with the busbar.

According to a further advantageous development of the invention, the arrangement contains devices for equalizing the filters and/or the busbars.

Further advantages and advantageous developments of the invention are given in the following description, the drawing and the claims. In the drawing

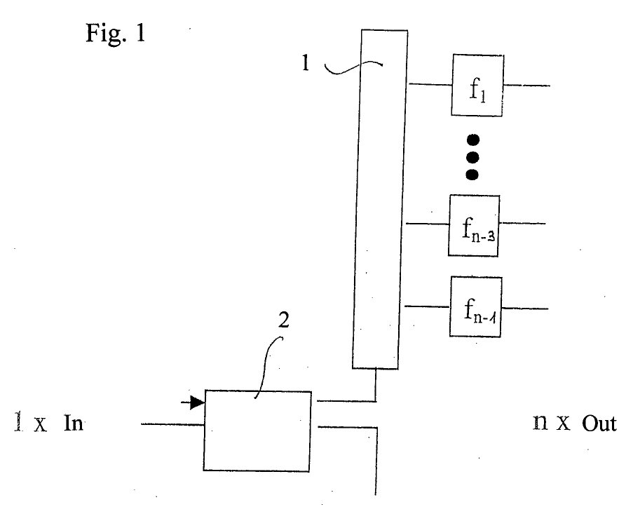

FIG. 1 shows high circuit order IMUX filter filters, which are connected over two busbars with a hybrid coupler and

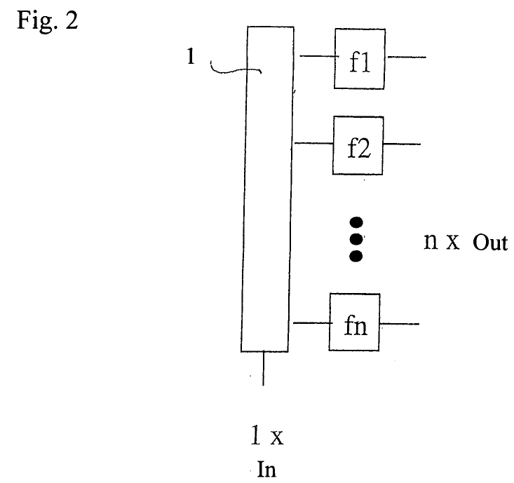

FIG. 2 shows high circuit order IMUX filters, which are connected with a low-loss bus bar.

As shown in FIG. 1, there is a low-loss busbar 1, which connects the bandpass filters 1, 3, . . . , (n-1) and a further low-loss busbar 1 for the remaining filters 2, 4, . . . , n. The “hockkreisigen” IMUX are connected non-contiguously over these two busbars 1 and the two busbars are connected over a hybrid coupler 2 to the IMUX instrument as a whole. The identical half for f2, f4 . . . , fn conceivably adjoins at the bottom.

As shown in FIG. 2, the low-loss busbar 1 connects the “hochkreisigen” IMUX bandpass filters 1, 2, . . . , n, which are directly adjacent in the frequency space, with one another.

All distinguishing features, shown in the specification, the subsequent claims and the drawing, may be essential to the invention individually as well as in any combinations with one another.

1. Input multiplexer (IMUX) for splitting a broad frequency band into a series of narrower frequency channels comprising of a bandpass filter per frequency channel, each filter having an input and an output, high circuit order bandpass filters with a circuit order of more than 6 have zero positions in the transmission function on the imaginary frequency axis in the vicinity of the passband for improving the flank steepness and a low variation in the group running time within the pass band, achieved by an external running time equalizer or further zero positions in the transmission function with a finite real part or a combination hereof, with each of these inputs coupled to a low loss bus bar, which comprises conducting pieces of optimized length.

2. The input multiplexer of claim 1, wherein the bus bar connects the bandpass filters non-contiguously.

3. The input multiplexer of claim 1, wherein the busbar connects the bandpass filters contiguously.

4. The input multiplexer of one of claims 1-3, wherein the bandpass filter and the busbar are constructed in the waveguide technique, the coaxial technique, the dielectric technique and/or the planar technique.

5. The input multiplexer of one of claims 1-3, wherein the geometry of the low loss busbar is combine or herringbone.

6. The input multiplexer of one of claims 1-3, wherein the bandpass filters comprises resonators in the single mode, dual mode, triple mode and/or in the quadruple mode.

7. The input multiplexer of one of claims 1-3, wherein the filters, with respect to their center frequency, are connected in any sequence with the busbar.

8. The input multiplexer of one of claims, 1-3, further comprising devices for equalizing the bandpass filters and/or the busbar.

9. The multiplex of one the of claims 1-3, the individual multiplexes are connected over hybrid couplers and/or power splitters.

10. The multiplexer of one of claims 1-3, wherein the overall arrangement of the multiplexer covers all channels of an IMUX.

11. The multiplex of one of the claims 1-3, wherein the filter functions are symmetrical or asymmetrical.
